(19) United States
(12) Patent Application Publication
(10) Pub. No.: US 2016/0267054 A1
(43) Pub. Date: Sep. 15, 2016

(54) METHOD FOR DETERMINING OPTIMUM REFERENCE DATA NUMBER FOR SMOOTHING MEASURED DATA AND METHOD FOR CORRECTING MEASURED DATA

(71) Applicant: Korea Institute of Science and Technology, Seoul (KR)

(72) Inventors: Sung Kyu KIM, Seoul (KR); Yongjoon KWON, Seoul (KR)

(73) Assignee: Korea Institute of Science and Technology, Seoul (KR)

(21) Appl. No.: 15/066,447

(22) Filed: Mar. 10, 2016

(30) Foreign Application Priority Data
Mar. 10, 2015 (KR) 10-2015-0033146

(51) Int. Cl. G06F 17/17; G01J 1/44

(52) U.S. Cl. CPC G06F 17/17; G01J 1/44

(57) ABSTRACT

Disclosed is a method for determining an optimum reference data number, which includes: smoothing measured data on the basis of different data numbers; obtaining a deviation of measured data before the smoothing and the smoothed measured data; and determining an optimum reference data number on the basis of the deviation. Also, disclosed is a method for correcting measured data, which includes: obtaining deviations of measured data and smoothed data obtained by smoothing the measured data; obtaining a reference deviation on the basis of the deviations; and correcting the measured data on the basis of the reference deviation.

### DESCRIPTION ABOUT NATIONAL RESEARCH AND DEVELOPMENT SUPPORT

This study was supported by Project No. GK14D0200 of Ministry of Science, ICT and Future Planning.

### CROSS-REFERENCE TO RELATED APPLICATION

This application claims priority to Korean Patent Application No. 10-2015-0033146, filed on Mar. 10, 2015, and all the benefits accruing therefrom under 35 U.S.C. §119, the contents of which in its entirety are herein incorporated by reference.

### BACKGROUND

1. Field

Embodiments relate to a method for determining a reference data number as a smoothing parameter called window size for smoothing measured data and a method for correcting measured data, and more particularly, to a method for determining a reference data number for smoothing measured data while ensuring reliability and a method for correcting defective data among measured data by using the measured data and smoothed measured data.

2. Description of the Related Art

An autostereoscopic image display device implements a three-dimensional stereoscopic image by adjusting a multi-view image to spatially form each visual field so that different images at different viewpoints are recognized by both eyes of an observer. Since the autostereoscopic image display device has different functions and performance depending on, for example, an optimum viewing distance, an interval between viewpoints, a crosstalk, a contrast, an optical characteristic at each viewpoint such as Moire phenomenon and a visual field characteristic, it is an essential and important process to measure optical characteristics of the stereoscopic image display device and analyze the corresponding device based on quantified objective data.

An optical characteristic measurement device means a device for measuring light quantity from samples of an image display device by means of a sensor for measuring light quantity (or, luminous intensity) (for example, a charge coupled device (CCD) or a complementary metal-oxide semiconductor (CMOS)). FIG. 1 shows an example of the optical characteristic measurement device.

A measurement sensor of the optical characteristic measurement device includes a plurality of pixels with substantially different sensitivities and thus may have irregular measurement values as shown in FIG. 2 with respect to a uniform light source. In addition, due to irregular light emission of a light source along with time, time-dependent random noise may also occur at the measurement values.

Therefore, in order to accurately analyze optical characteristics by using light quantity measurement values, data smoothing should be accompanied by means of measured data averaging or the like. In the smoothing, it is important that noise (wiggle) observed at the measured data is minimized and also data is fit to the center or within a range of a width (ΔI; FIG. 2) where most data are present.

Among several smoothing methods commonly used, there is representatively used a Savitzky-Golay fitting method, which has two smoothing parameter associated with a moving average and local moving polynomial-expression fitting method, unless a specific model (or, function) is fit. Among them, in case of a simple moving average (SMA), most basically and easily used, when the number of measurement values used for obtaining an average is N, the following equation may be applied.

$$\overline{{x}_{i + ( N + 1 ) / 2}} = \frac{{\sum }_{k = i + 1}^{i + N} {x}_{k}}{N}$$

At this time, in the equation, i is a natural number over 0, and N is an odd natural number, wherein N is nothing but a smoothing parameter (or window size) for SMA.

However, in case of the SMA, the (N−1)/2 number of measurement values at both right and left ends are not averaged. In the Savitzky-Golay fitting method, the (N−1)/2 number of measurement values at both right and left ends are also not fit.

In addition, in the moving average method, when measurement values are similar to Gaussian or has a macroscopic data distribution other than a linear form, in general cases, as an averaged data number (namely, N) increases, noise disappears in the smoothed data, but a deviation from original measurement values increases. In other words, as N increases, the smoothing effect increases, but the fitting effect decreases. This phenomenon appears similarly in the Savitzky-Golay fitting method.

In addition, if N is over a certain value, values near a maximum value or maximum value of the smoothed data may not be located within a deviation width near a maximum value (peak) in a macroscopic profile or the originally measured data. For example, if FIGS. 3 and 4 are compared, the difference in data fitting according to an averaged data number may be found. FIG. 3 shows light quantity of the measured data corresponding to one view of an autostereoscopic image display device at a distance from the device and a result obtained by applying SMA where the data number of 2001 set to be averaged for all the data. The measured data are depicted in yellow, and the smoothed data are depicted in black. Referring to FIG. 3, it may be found that near the maximum value of the measured data, smoothed data does not present within a certain width where original measured data are present. Meanwhile, referring to FIG. 4 showing a result obtained by SMA where the averaged data number is lowered to 201, even though noise (wiggle) may be observed relatively further at the smoothed data near the maximum value, it may be found that reliable data relatively well fit are obtained on the center of the distribution width of the measured data.

Therefore, there is demanded an objective and scientific analysis method for finding a reference data number which may allow smoothing with minimized noise while maintaining reliability of data while smoothing the data.

Meanwhile, even though measured data obtained from a measurement sensor are smoothed, if the measured data contains defective data (or, defective measurement value), it may deteriorate the reliability of data and also disturb accurate analysis using the smoothed data.

The defective data mean measurement values seriously deviating from a range where most measurement values are present, due to defective pixels of the measurement sensor or time-dependent random noise. FIG. 5 shows an example of luminous intensity measurement value with respect to a uniform light source, and data A to D seriously deviating from a range (ΔI) where most measurement values are present correspond to defective data.

Therefore, there is demanded a method capable of objectively defining and correcting such defective data.

### RELATED LITERATURES

Non-Patent Literature

(Non-patent Literature 1) H. Azami, K. Mohammadi and B. Bozorgtabar, “An Improved Signal Segmentation Using Moving Average and Savitzky-Golay Filter”, Journal of Signal and Information Processing, Vol. 3, No. 1, 2012, pp. 39-44

### SUMMARY

The present disclosure is directed to objectively determining a reference data number, which may ensure reliability of data while smoothing the data and also minimize noise or fluctuation.

In an embodiment of the present disclosure, a defective measurement value included in measured data may be defined and corrected using an objective reference.

In one aspect of the present disclosure, there is provided a method for determining an optimum reference data number, comprising: smoothing measured data on the basis of different data numbers; obtaining a deviation of measured data before the smoothing (or, pre-smoothing measured data) and the smoothed measured data; and determining an optimum reference data number on the basis of the deviation.

In an embodiment, the smoothing of measured data on the basis of different data numbers may include: smoothing the measured data on the basis of a first data number; and smoothing the measured data on the basis of a data number smaller than the first data number, and the first data number may be a data number corresponding to a width of a measured data profile, a value not greater than a half of the data number corresponding to the width of the measured data profile, or a maximum value of measured data having the same value in the measured data profile.

In an embodiment, the obtaining of a deviation of the pre-smoothing measured data and the smoothed measured data may include: obtaining a deviation index calculated using a magnitude of the deviations of the pre-smoothing measured data and measured data smoothed on the basis of a specific data number.

In an embodiment, the determining of an optimum reference data number on the basis of the deviation may include: calculating a change rate of the deviation index according to a reference data number; and determining the optimum reference data number on the basis of a reference data number when the change rate of the deviation index is a smallest non-negative value or a minimum.

In an embodiment, the deviation index may be a root mean square (RMS) value of the deviations or an average of absolute values of the deviations.

In an embodiment, the smoothing may be performed by means of moving average or Savitzky-Golay fitting.

In another aspect of the present disclosure, there is provided a measured data smoothing device, comprising: a reference data number determining unit configured to determining a reference data number for smoothing; a smoothing unit configured to smooth measured data on the basis of the data number determined by the reference data number determining unit; a deviation calculating unit configured to calculate a deviation of the pre-smoothing measured data and the smoothed measured data; and an optimum reference data number determining unit configured to determine an optimum reference data number on the basis of the deviation calculated by the deviation calculating unit.

In an embodiment, the reference data number determining unit may determine a data number corresponding to a width of a measured data profile, a value not greater than a half of the data number corresponding to the width of the measured data profile, or a maximum value of data numbers having the same value, as a first reference data number, and determine a value smaller than the first reference data number as a second reference data number.

In an embodiment, the deviation calculating unit may obtain a deviation index calculated using a magnitude of the deviations of the pre-smoothing measured data and measured data smoothed on the basis of a specific data number.

In an embodiment, the optimum reference data number determining unit may include a deviation change rate calculating unit configured to calculate a change rate of the deviation index according to a reference data number, and determine the optimum reference data number as a reference data number when the change rate of the deviation index is a smallest non-negative value or a minimum.

In an embodiment, the deviation index may be a root mean square (RMS) value of the deviations or an average of absolute values of the deviations.

In an embodiment, the smoothing may be performed by means of moving average or Savitzky-Golay fitting.

In another aspect of the present disclosure, there is provided a computer-readable recording medium, which includes commands for executing the method for determining an optimum reference data number according to an embodiment.

In another aspect of the present disclosure, there is provided a computer program for executing the method for determining an optimum reference data number according to an embodiment in a computer.

In another aspect of the present disclosure, there is provided a method for correcting measured data, comprising: obtaining deviations of measured data and smoothed data obtained by smoothing the measured data; obtaining a reference deviation on the basis of the deviations; and correcting the measured data on the basis of the reference deviation.

In an embodiment, the obtaining of deviations may include obtaining the smoothed data by smoothing the measured data on the basis of the optimum reference data number determined by the method for determining an optimum reference data number according to an embodiment.

In an embodiment, the obtaining of a reference deviation on the basis of the deviations may include: calculating a first average which is an average of deviations having a positive value among the deviations; determining a first reference deviation on the basis of the first average; calculating a second average which is an average of deviations having a negative value among the deviations; and determining a second reference deviation on the basis of the second average, and the correcting of the measured data on the basis of the reference deviation may include: comparing the deviations having a positive value with the first reference deviation; correcting a first defective data whose deviation to the smoothed data has a positive value and is greater than the first reference deviation, among the measured data; comparing the deviations having a negative value with the second reference deviation; and correcting a second defective data whose deviation to the smoothed data has a negative value and whose absolute value is greater than an absolute value of the second reference deviation, among the measured data.

In an embodiment, the obtaining of a reference deviation on the basis of the deviations may include: calculating an average of absolute values of the deviations; and determining the reference deviation on the basis of the average of the absolute values of the deviations, and the correcting of the measured data on the basis of the reference deviation may include: comparing the absolute values of the deviations with the reference deviation; correcting a first defective data whose deviation to the smoothed data has a positive value and is greater than the first reference deviation, among the measured data; and correcting a second defective data whose deviation to the smoothed data has a negative value and whose absolute value is greater than the second reference deviation, among the measured data.

In an embodiment, the correcting of a first defective data may include: obtaining a first maximum deviation which has a positive value and whose absolute value is maximum, among the deviations; and correcting the first defective data on the basis of the first maximum deviation, and the correcting of a second defective data may include: obtaining a second maximum deviation which has a negative value and whose absolute value is maximum, among the deviations; and correcting the second defective data on the basis of the second maximum deviation.

In another aspect of the present disclosure, there is provided a measured data correcting device, comprising: a deviation calculating unit configured to calculate deviations of measured data and smoothed data obtained by smoothing the measured data; a reference deviation calculating unit configured to calculate a reference deviation for determining data to be corrected, on the basis of the deviations; a deviation comparing unit configured to compare the deviations with the reference deviation; and a correcting unit configured to correct the measured data on the basis of the comparison result of the deviations and the reference deviation.

In an embodiment, the deviation calculating unit may include the measured data smoothing device according to an embodiment.

In an embodiment, the reference deviation calculating unit may include an average calculating unit for calculating a first average which is an average of deviations having a positive value among the deviations and a second average which is an average of deviations having a negative value among the deviations, determine a first reference deviation on the basis of the first average, and determine a second reference deviation on the basis of the second average, the deviation comparing unit may compare the deviations having a positive value with the first reference deviation and compare the deviations having a negative value with the second reference deviation, and the correcting unit may correct a first defective data whose deviation to the smoothed data has a positive value and is greater than the first reference deviation and a second defective data whose deviation to the smoothed data has a negative value and whose absolute value is greater than an absolute value of the second reference deviation, among the measured data.

In an embodiment, the reference deviation calculating unit may include an average calculating unit for calculating an average of absolute values of the deviations, and determine the reference deviation on the basis of the average of the absolute values of the deviations, the deviation comparing unit may compare the absolute values of the deviations with the reference deviation, and the correcting unit may correct a first defective data whose deviation to the smoothed data has a positive value and is greater than the first reference deviation and a second defective data whose deviation to the smoothed data has a negative value and whose absolute value is greater than the second reference deviation, among the measured data.

In an embodiment, the correcting unit may include a maximum deviation determining unit for determining a first maximum deviation which has a positive value and whose absolute value is maximum, among the deviations, and a second maximum deviation which has a negative value and whose absolute value is maximum, among the deviations, correct the first defective data on the basis of the first maximum deviation, and correct the second defective data on the basis of the second maximum deviation.

In another aspect of the present disclosure, there is provided a computer-readable recording medium, which includes commands for executing the method for correcting measured data according to an embodiment.

In another aspect of the present disclosure, there is provided a computer program for executing the method for correcting measured data according to an embodiment in a computer.

In another aspect of the present disclosure, there is provided a method for processing measured data, comprising: correcting measured data by using the method for correcting measured data according to an embodiment; determining an optimum reference data number by applying the method for determining an optimum reference data number according to an embodiment to the corrected measured data; and smoothing the corrected measured data on the basis of the determined optimum reference data number.

According to an embodiment of the present disclosure, when measured data are smoothed, since the smoothed data are fit at the center of a width where measured data before smoothing are distributed, or within the width, it is possible to determine an optimal reference data number capable of maximizing the data smoothing effect while ensuring reliability of the smoothed data.

According to an embodiment of the present disclosure, the reliability of measured data may be enhanced by correcting a defective measurement value caused by a defective pixel of a sensor or external factors.

Therefore, according to embodiments of the present disclosure, the reliability of data may be maintained while smoothing or correcting measured data, and accordingly characteristics of a device having optical characteristics, such as an autostereoscopic image display device, may be more accurately analyzed.

### BRIEF DESCRIPTION OF THE DRAWINGS

FIG. 1 schematically shows an example of an optical characteristic measurement system.

FIG. 2 shows an example of luminous intensity measured data with respect to uniform light quantity.

FIG. 3 shows light quantity of the measured data corresponding to one viewpoint of an autostereoscopic image display device at a distance from the device and a result obtained by applying SMA where an averaged data number of 2001 is set to the data.

FIG. 4 shows the light quantity of the measured data identical to FIG. 3 and a result obtained by applying SMA where an averaged data number of 201 is set to the data.

FIG. 5 shows an example of luminous intensity measured data with respect to a uniform light source.

FIG. 6 shows an example of light quantity of the measured data corresponding to one view of an autostereoscopic image display device at a distance from the device.

FIG. 7 is a graph showing a relatively flat portion near a maximum value of the light quantity measured data of FIG. 6 as an enlarged view.

FIG. 8 is a graph exemplarily showing a root mean square (RMS) value of deviations of measured data and smoothed data, obtained by performing a method for determining an optimum reference data number according to an embodiment of the present disclosure, according to a reference data number.

FIG. 9 is a graph showing a change rate of RMS values of the deviations of measured data and smoothed data of FIG. 8, according to a reference data number.

FIG. 10 shows an example of data distribution having linearity in a macroscopic aspect and having fluctuation.

FIG. 11 is a graph showing a RMS value of the deviations of original data and SMA-applied data according to a reference data number, when SMA is applied to the data of FIG. 10.

FIG. 12 shows an example of a data distribution curve macroscopically having a Gaussian-like form having no microscopic data fluctuation.

FIG. 13 is a graph showing a RMS value of the deviations of original data and SMA-applied data according to a reference data number, when SMA is applied to the data of FIG. 12.

FIG. 14 is a block diagram showing a measured data smoothing device according to an embodiment of the present disclosure.

FIG. 15 shows an example of raw data obtained by measuring luminous intensity of a linear light source.

FIG. 16 shows a result obtained by applying the method for correcting measured data according to an embodiment of the present disclosure to the raw data of FIG. 15.

FIG. 17 shows an example of raw data obtained by measuring luminous intensity with respect to one viewpoint of an autostereoscopic image display device at a distance from the device.

FIG. 18 shows a result obtained by applying the method for correcting measured data according to an embodiment of the present disclosure to the raw data of FIG. 17.

FIG. 19 is a block diagram showing a measured data correcting device according to an embodiment of the present disclosure.

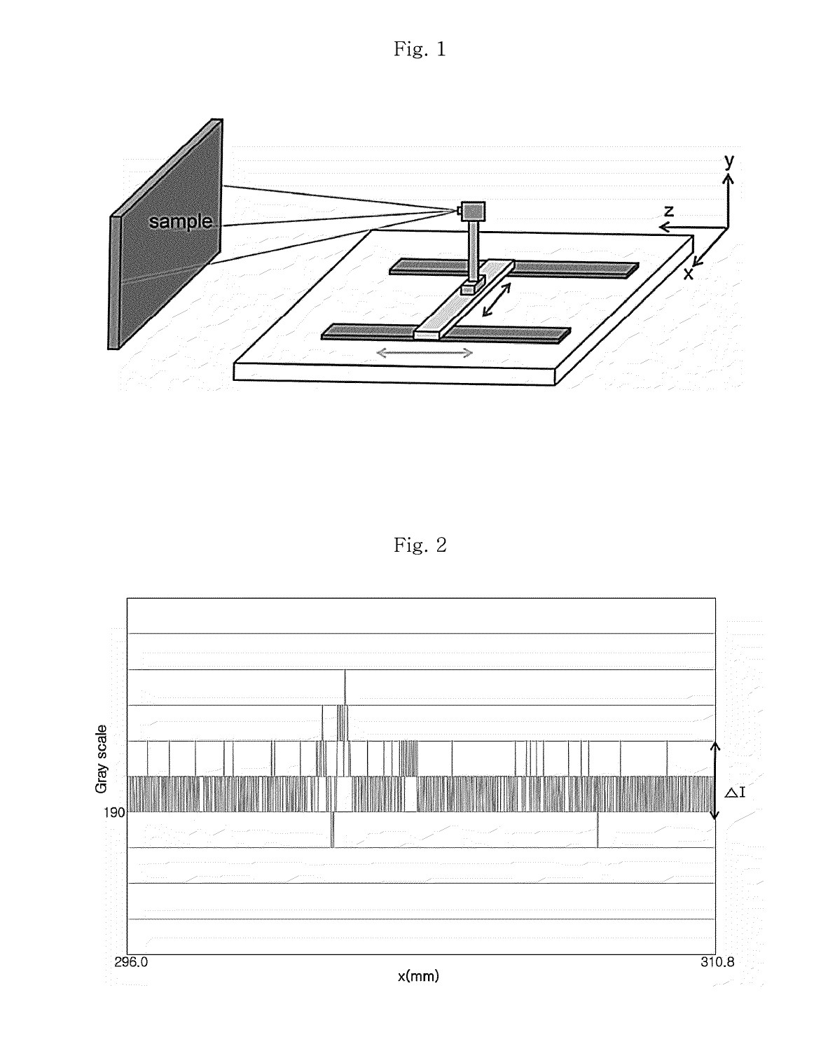

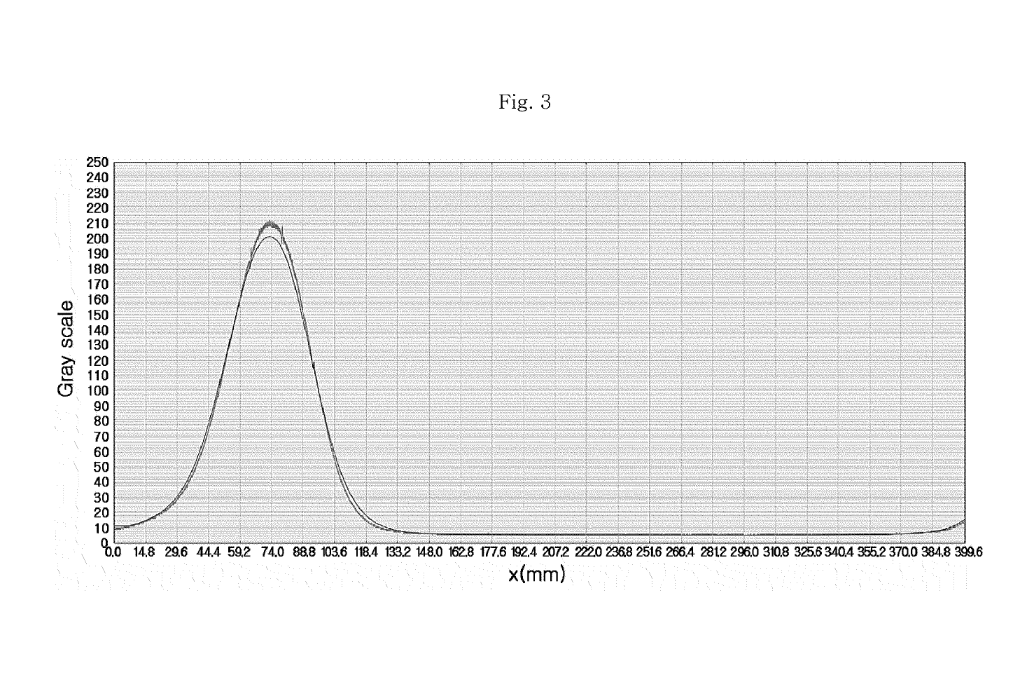

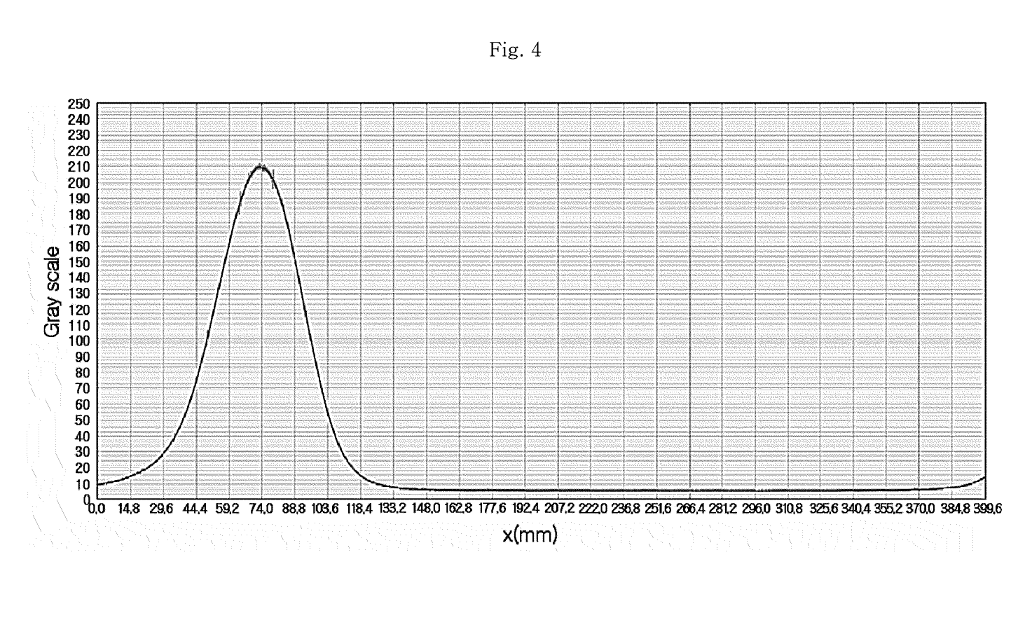

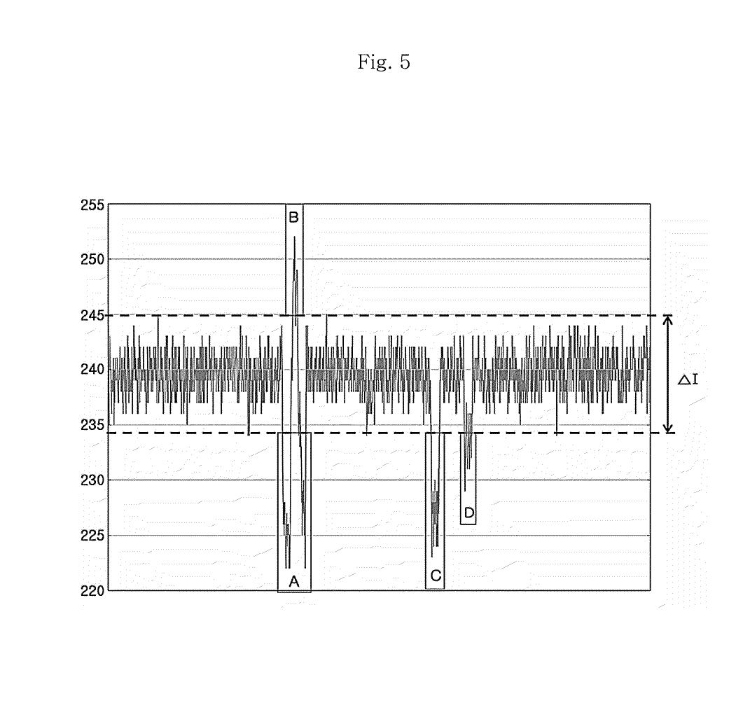

### DETAILED DESCRIPTION

Hereinafter, embodiments of the present disclosure will be described in detail with reference to the accompanying drawings.

A method for determining an optimum reference data number according to embodiments of the present disclosure will be described.

First, when smoothing data, the number of data (or, a data number) subject to averaging or polynomial expression fitting at once is determined. In addition, on the basis of the determined data number, measured data are smoothed. The smoothing may employ moving average or Savitzky-Golay fitting. The moving average may be a simple moving average (SMA), but may employ any kind of moving average, without being limited thereto.

The measured data may mean raw data not processed after being obtained from a measurement sensor, or rough data processed in any way after being obtained from a measurement sensor. In other words, any data derived from a measurement value may correspond to the measured data. Hereinafter, a measurement target will be luminous intensity, for example, but the measurement target is not limited thereto but may include any kind of data measured using a sensor.

In addition, the reference data number means the number of data which are subject to averaging or polynomial expression fitting at once when the data are smoothed. For example, in the moving average, when each 101 data are averaged while moving with respect to 10000 data in total, the reference data number means an averaged data number and becomes 101. In other case, in the Savitzky-Golay fitting, if the reference data number is 101, this means that polynomial expression fitting is applied to each 101 data while moving in the measured data.

A first reference data number (N₀), which is an initial reference data number when smoothing measured data for the first time, may be any value equal to or smaller than the number of entire measured data.

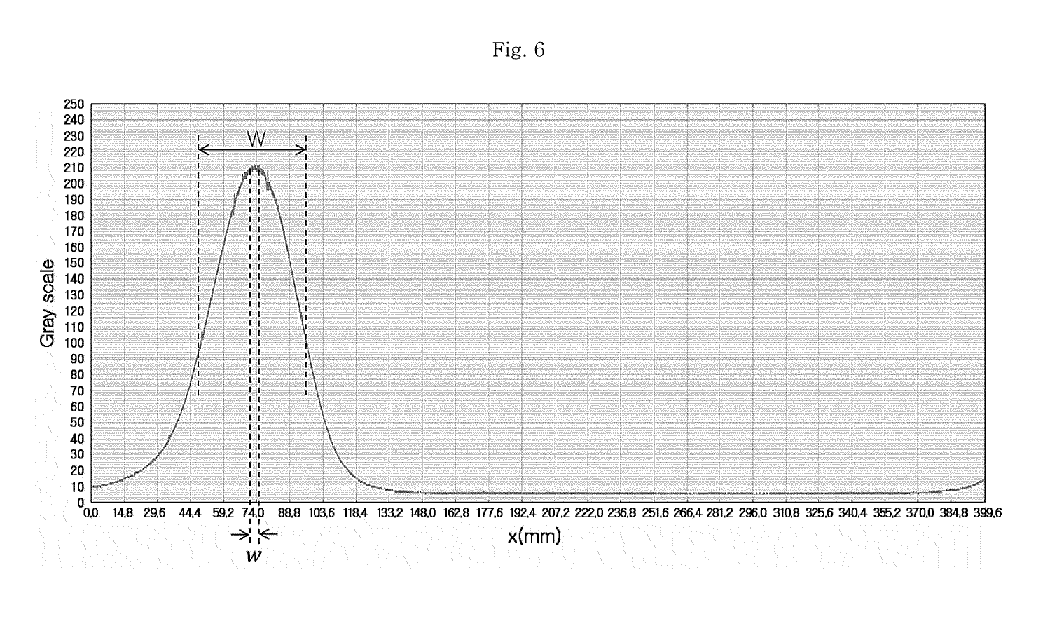

In an embodiment, the first reference data number (N₀) may be set as a data number corresponding to a width (W) of a profile formed by the measured data, or a value not greater than a half of the data number corresponding to the width (W) of a profile formed by the measured data. A macroscopic profile means a region in which meaningful values representing luminous intensity among the measured data exhibit a specific distribution form. The distribution form may have, for example, a Gaussian-like profile (namely, a profile where a curvature changes to the maximum near a maximum value) as shown in FIG. 6.

At this time, the width (W) of the profile means a width of data having a measurement value not smaller than a predetermined reference value or a horizontal width of two points having a measurement value identical to the reference value, and may be, for example, a full width at half maximum or a full width.

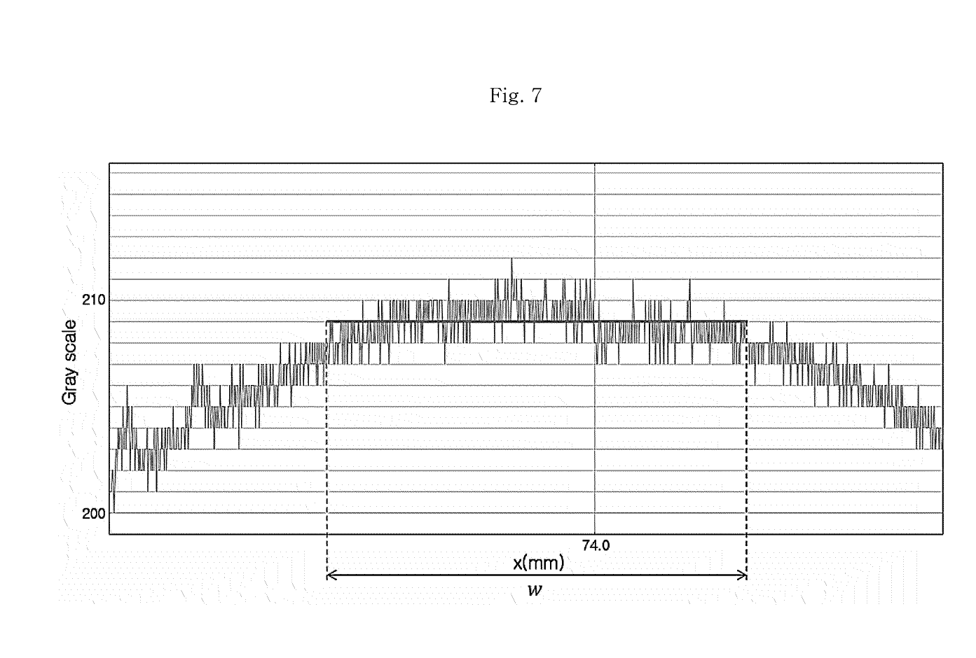

In an embodiment, the first reference data number (N₀) may be set in consideration of data distribution or the like on the basis of a maximum value of the data number having the same value near a point (for example, a point having a maximum value (peak)) where a macroscopic curvature is maximum in the Gaussian-like profile, and for example, may be set as a maximum value of the data number having the same value. The light quantity data measured when an image of a specific viewpoint is displayed at an autostereoscopic image display device generally exhibits a profile having a maximum value at a local portion as shown in FIG. 6, and also exhibits a relatively flat portion (plateau) near a maximum value having a knee point as shown in FIG. 7. In other words, the width (w) or number of data having the same value at the plateau near the maximum value becomes a maximum.

In other case, in an embodiment, when it is intended to perform smoothing while increasing the reference data number (N) gradually, the first reference data number (N₀) may be set to be 3 or above.

By providing an objective criterion for setting the first reference data number (N₀) as described above, the time required for finding a reference data number for smoothing while maintaining data reliability may be shortened.

After the measured data are smoothed on the basis of the first reference data number (N₀), the smoothed value is subtracted from each measurement value before smoothing to calculate a deviation of the measured data and the smoothed data. The deviation (Δxⱼ) of smoothed values (x̅ⱼ) of j^{th} measurement value (xⱼ) and j^{th} measurement value is as in Equation 1 below.

Δxⱼ=xⱼ−x̅ⱼ Equation 1

After that, a root mean square (RMS) value (δ) of the deviations of the measured data and the smoothed measured data is calculated. Hereinafter, for convenient, the RMS value of the deviations of the measured data and the smoothed measured data is called “RMS-deviation”. When the number of measured data whose deviation is calculated is D, the RMS-deviation may be calculated using Equation 2 below, and this value varies depending on the reference data number of the smoothing.

$$δ ≡ \sqrt{\frac{{\sum }_{j = 1}^{D} {( {x}_{j} - {\overline{x}}_{j} )}^{2}}{D}} \qquad Equation 2$$

In a similar way, the measured data are smoothed while gradually increasing or decreasing the reference data number, and RMS-deviation is calculated. The reference data number may be changed at regular intervals during the smoothing process. In an embodiment, smoothing is applied while decreasing the reference data number (N) to satisfy Equation 3 below.

N=N₀−a*m(m=1,2, . . . ) Equation 3

In Equation 3, a is a parameter which may be given depending on circumstances and may be a value of 10 or above and 50 or below. If the RMS-deviation is calculated while increasing N, a plus sign is applied in Equation 3 instead of a minus sign.

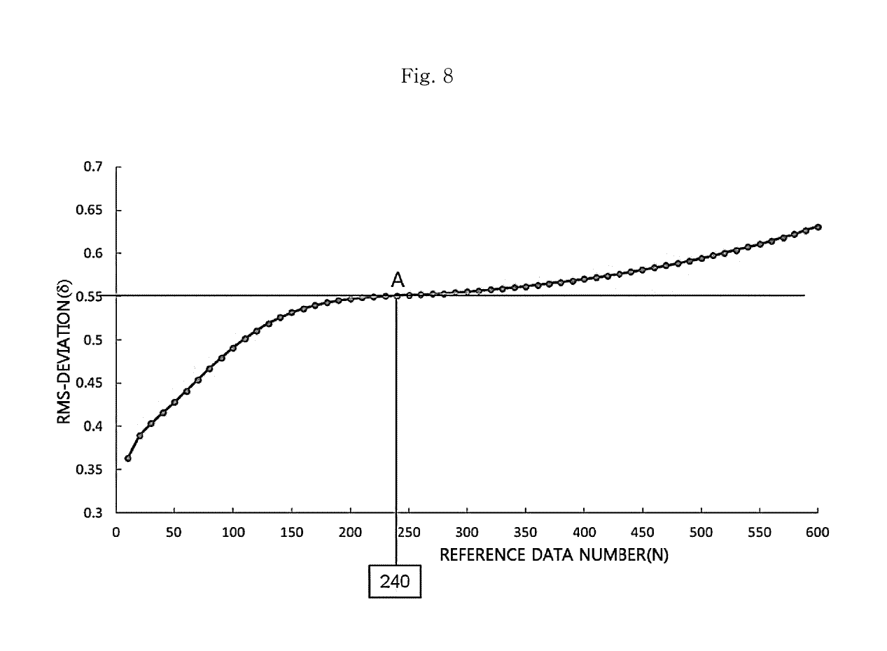

FIG. 8 is a graph exemplarily showing RMS-deviations, obtained by performing a method for determining an optimum reference data number according to an embodiment of the present disclosure, according to a reference data number. SMA is used as a smoothing method.

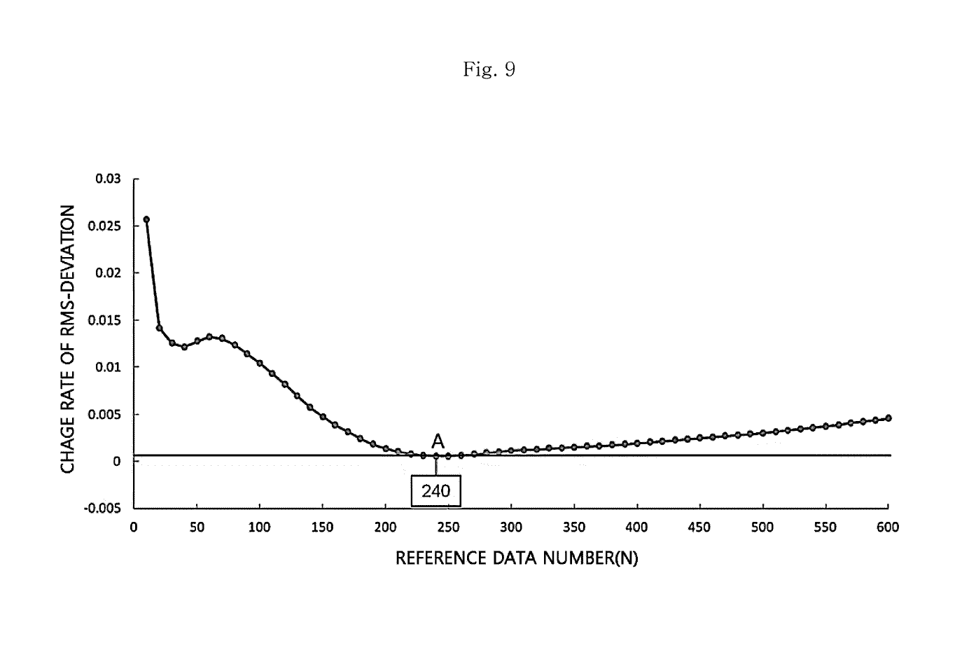

After RMS-deviations are obtained with respect to a plurality of reference data numbers, a change rate of the RMS-deviations according to the reference data number is calculated. FIG. 9 is a graph showing a change rate of the RMS-deviations of FIG. 8, according to a reference data number.

After that, a reference data number (Nc) when the change rate of RMS-deviation has a non-negative and minimum value is extracted, and an optimal reference data number is determined on the basis of this value (Nc). In other case, an optimal reference data number may also be determined on the basis of a reference data number (Nc) when the change rate of RMS-deviation has a minimum value. In this case, a reference data number when the change rate of the RMS-deviation has a negative value and a maximum absolute value may be determined as an optimal reference data number.

For example, the reference data number (Nc) determined through the above method may be determined as an optimal reference data number, or reference data numbers of a certain range including the reference data number (Nc) determined through the above method may be determined as an optimal reference data number range.

If the measured data are smoothed on the basis of the optimal reference data number (Nc), it is possible to remove fluctuation and noise of the measured data and also obtain reliable smoothed data fit to a center of width, or into a range of the width, where the measured data before smoothing are distributed.

Even though a RMS value of deviations of the measured data and the smoothed data has been used to determine an optimum reference data number, a value (namely, a deviation index) capable of representing a difference of deviations by using magnitudes or absolute values of the deviations of the measured data and the smoothed data may also be used instead of the RMS value. For example, the deviation index may be an arithmetic average of absolute values of the deviations, a sum of absolute values of the deviations, a multiply of n^{th} power (n=2, 3, . . . ) of each deviation, or the like, instead of the RMS value of deviations of the measured data and the smoothed data. In this case, similarly, an optimum reference data number may be determined on the basis of a reference data number when a change rate of the deviation index has a smallest non-negative value or is minimal.

In addition, by performing the method for determining an optimum reference data number according to an embodiment of the present disclosure by using a computer program or a recording medium storing the computer program, an optimum reference data number may be automatically found within a short time.

When the measured data are smoothed while changing the reference data number by applying the moving average, a point A representing an optimum reference data number as shown in FIGS. 8 and 9 is exhibited due to the following reasons.

A light quantity distribution profile with respect to one viewpoint image of an autostereoscopic image display device using a lenticular lens or a parallax barrier has a maximum value, and its light quantity gradually decreases as growing away from the maximum value. This feature is a global feature in a macroscopic view, and the measured data exhibit small fluctuation in a microscopic view. In other words, in a microscopic view, a local feature where data have serious fluctuation is provided.

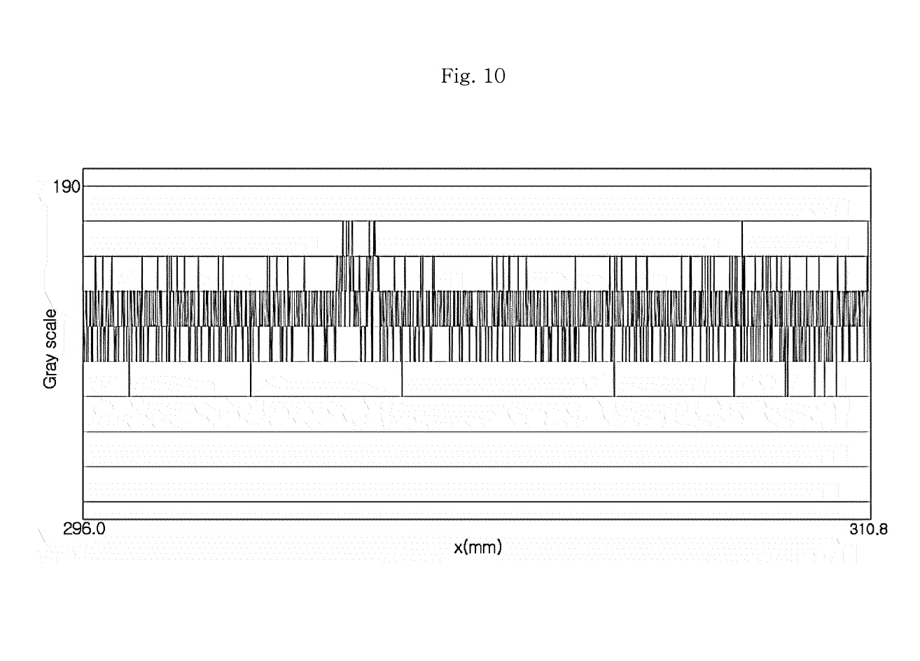

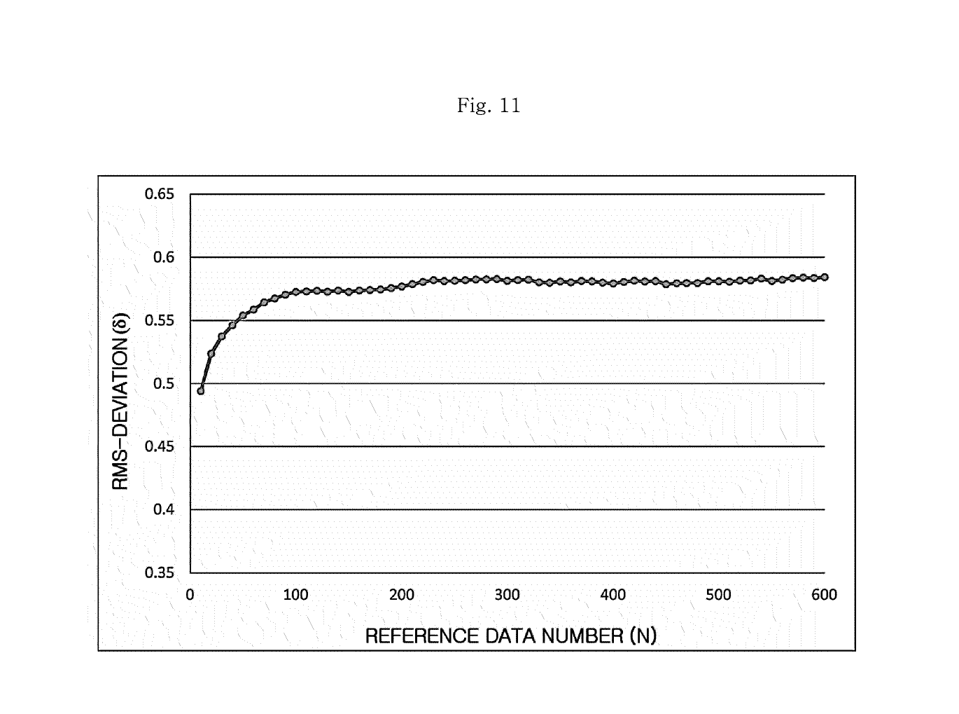

A data distribution having linearity in a macroscopic view is similar to the distribution depicted in FIG. 10, and if the data of FIG. 10 are smoothed by applying SMA while changing the reference data number, a RMS value of deviations of the original data and the SMA-applied data according to the reference data number is depicted as in FIG. 11. Referring to FIG. 11, in case of a linear data distribution in a macroscopic view, it may be found that reliability of the data fitting is ensured regardless of the reference data number. In particular, if the reference data number (N) is about 100 or above (N=100 or above) which is the number of reference data at which macroscopic linearity of the data is maintained, substantially constant deviation is exhibited regardless of the reference data number. FIGS. 10 and 11 show an example for illustrating a phenomenon exhibited at a left side on the basis of the point A of FIG. 8.

Meanwhile, a Gaussian-like distribution curve in a macroscopic view has non-linearity, different from a function where linearity is maintained. In a macroscopic view, in a region where a slope of the distribution curve varies greatly, the degree of non-linearity of the data corresponding to the reference data number (N) increases. In other words, if the distribution curve has non-linearity like a Gaussian form, the reference data number and the data fitting reliability have close relationship. As the reference data number decreases, non-linearity in a macroscopic view decreases, and linearity is given to some extent.

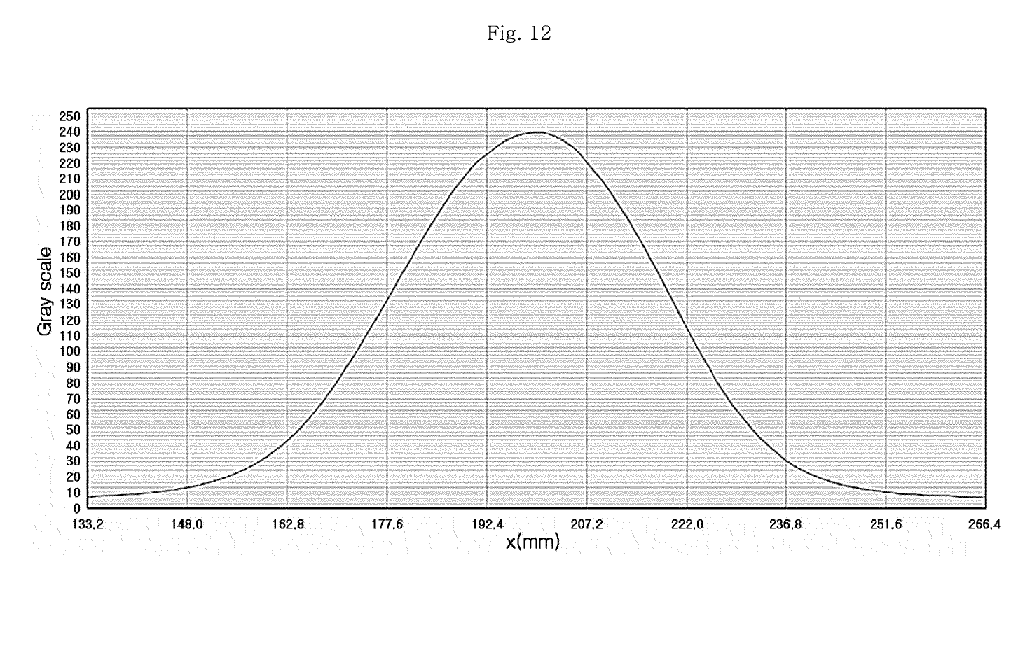

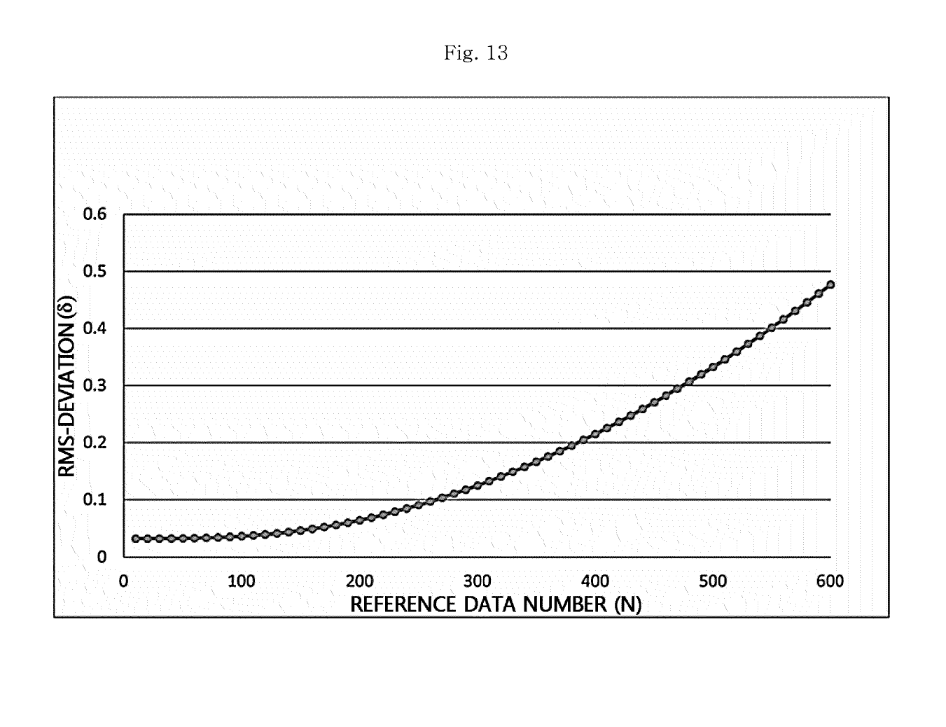

For example, if a Gaussian-like distribution curve has no microscopic data fluctuation as shown in FIG. 12, as the reference data number is smaller, the linearity of the measured data in a viewpoint of the (window) size corresponding to the reference data number is greater, and the data fitting reliability is greater. FIG. 13 is a graph showing a RMS value of the deviations of original data and SMA-applied data according to a reference data number, when SMA is applied to the data of FIG. 12. Referring to FIG. 13, it may be found that as the reference data number increases, the RMS value is converged to 0. FIGS. 12 and 13 show an example for illustrating a phenomenon exhibited at a right side on the basis of the point A of FIG. 8.

As another example, if a Gaussian-like distribution curve has microscopic fluctuation, as shown in FIG. 8, to a specific reference data number (namely, the point A), as the reference data number (N) decreases, linearity in a macroscopic view increases. In other words, the data averaged on the basis of the reference data numbers (Nc) of the point A are obtained from relatively the most linear feature of measured data in a viewpoint of the (window) size corresponding to the reference data number (Nc).

Meanwhile, if the reference data number (N) decreases to the point A or below in FIG. 8, the microscopic characteristic (namely, fluctuation) of the data gives an influence on the smoothed data. Therefore, as the reference data number decreases, the RMS-deviation decreases, and the data fitting reliability (here, the reliability means the degree of reflecting the original measured data) increases, but the smoothing effect decreases so as to be close to the original measured data before smoothing. In other words, the purpose of smoothing to remove noise or the like of data cannot be accomplished. In addition, as the reference data number (N) decreases, linearity of measured data in a viewpoint of the (window) size corresponding to the reference data number (N) decreases again due to the influence of the data fluctuation in a microscopic view. For example, referring to FIG. 8, this phenomenon is initiated at a reference data number of the point A or below, and as the reference data number decreases, non-linearity increases again.

Therefore, the data may be regarded as ensuring reliability after smoothing when linearity of the measured data is a maximum in a viewpoint of the (window) size corresponding to a reference data number. For this reason, the optimal reference data number becomes a point where the change rate of the RMS-deviation is a minimum, namely the point A.

Even though it has been illustrated based on an example where the data distribution has a Gaussian form, the method for determining a reference data number according to the present disclosure may be applied to any case where the data distribution has a microscopic data fluctuation with a curvature in a macroscopic form (for example, a trapezoidal distribution), though not having a Gaussian form, and an optimum reference data number where the smoothed data has maximum linearity of measured data may be found.

In case of Savitzky-Golay fitting, when the reference data number changes, the smoothing effect and the fitting reliability also exhibit trade-off relationship, and thus a criterion of a data number subject to polynomial expression fitting at once by means of the optimum reference data number determining method as described above may be prepared.

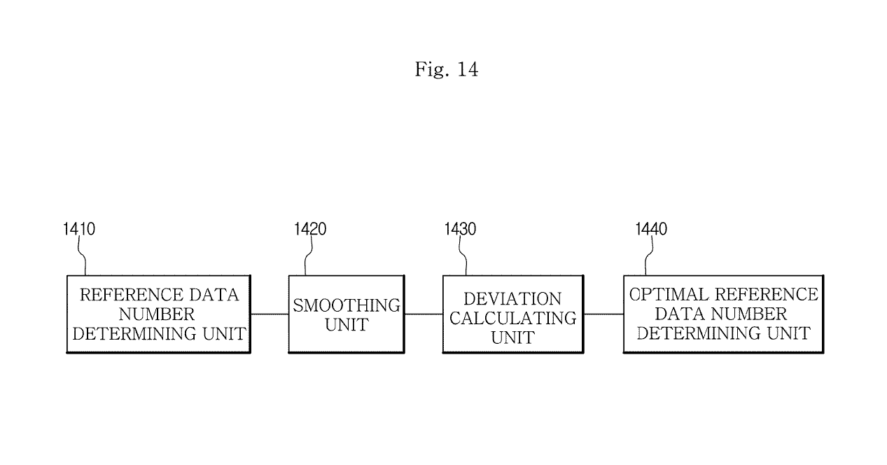

FIG. 14 is a block diagram showing a measured data smoothing device according to an embodiment of the present disclosure. The measured data smoothing device according to an embodiment of the present disclosure may be configured to perform the method for determining an optimum reference data number according to the above embodiment.

Referring to FIG. 14, the measured data smoothing device includes a reference data number determining unit 1410 for determining a reference data number for smoothing, a smoothing unit 1420 for smoothing measured data on the basis of the determined reference data number, a deviation calculating unit 1430 for calculating a deviation of the measured data before smoothing (or, the pre-smoothing measured data) and the smoothed measured data, and an optimum reference data number determining unit 1440 for determining an optimum reference data number on the basis of the deviation calculated by the deviation calculating unit 1430.

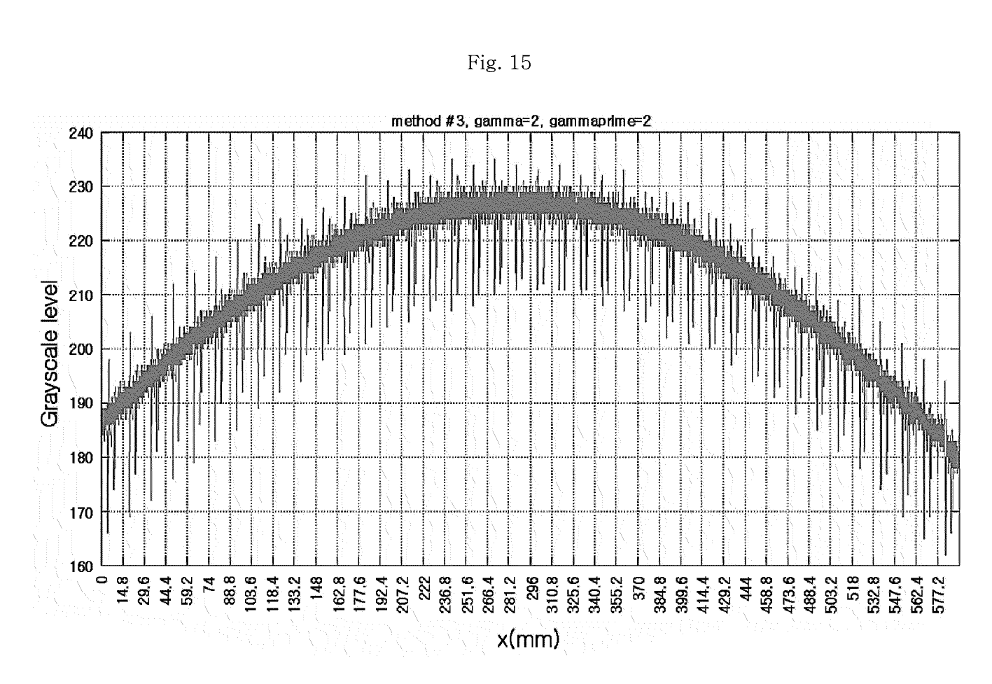

Meanwhile, if the measured data has defective data as shown in FIG. 15, more reliable data may be ensured by extracting and correcting the defective data.

Hereinafter, a method for correcting measured data according to embodiments of the present disclosure will be described.

Obtaining a Deviation of Measured Data and Smoothed Data

First, the measured data are smoothed to ensure reliability, thereby obtaining smoothed data. At this time, the reference data number may be determined by means of the optimum reference data number determining method according to an embodiment of the present disclosure, which ensures data fitting reliability as described above.

If the smoothed data are obtained, a deviation (Δxⱼ) of the measurement value before smoothing and the smoothed measurement value is calculated. The deviation (Δxⱼ) may be expressed as in Equation 1. The deviation is classified into values smaller than 0, 0, and values greater than 0.

Determining a Reference Deviation for Determining Defective Data

Based on the calculated deviations, a reference deviation for determining whether data having a positive deviation (namely, deviation greater than 0) equal to or greater than a predetermined value is treated as defective data or data having a negative deviation (namely, deviation smaller than 0) equal to or smaller than a predetermined value is treated as defective data is determined.

In an embodiment, the reference deviation may include a first reference deviation for determining defective data among positive deviations and a second reference deviation for determining defective data among negative deviations. The first reference deviation may be determined on the basis of a first average (Δ̅x̅₊̅) which is an average of the positive deviations, and the second reference deviation may be determined on the basis of a second average (Δ̅x̅₋̅) which is an average of the negative deviations. If there is an A number of positive deviations and a B number of negative deviations in total, the first average and second averages may be obtained as in Equation 4 and Equation 5 below.

$$\begin{matrix}\overline{Δ {x}_{+}} = \frac{{\sum }_{k = 1}^{A} Δ {x}_{k}}{A} & Equation 4 \\ \overline{Δ {x}_{-}} = \frac{{\sum }_{k = 1}^{B} Δ {x}_{k}}{B} & Equation 5\end{matrix}$$

For example, the first reference deviation and the second reference deviation may be γ₁ time of the first average and γ₂ of the second average, respectively. γ₁ and γ₂ are factors relating to the degree of determining defective data, and may be differently set according to the degree of demanded correction. γ₁ and γ₂ may have, respectively, values greater than 2 and smaller than 4. γ₁ and γ₂ may have the same value or different values.

In an embodiment, the reference deviation may apply the same value to the positive deviation and the negative deviation, and in this case, the reference deviation may be set on the basis of an average (Δ̅x̅) of absolute values of the deviations. The average of absolute values of the deviations may be obtained as in Equation 6 below.

$$\overline{Δ x} = \frac{{\sum }_{j}^{D} \vert Δ {x}_{j} \vert}{D} \qquad Equation 6$$

The reference deviation at this time may also be γ time of the average of absolute values of the deviations. In the above equation, D may include the number of total data having Δxⱼ other than 0 or the number of total data whose deviation is calculated, which may include data having Δxⱼ of 0.

Correcting Defective Data

In an embodiment, if the first reference deviation and the second reference deviation are determined as the reference deviation (namely, if a reference deviation for a positive deviation and a reference deviation for a negative deviation are determined independently), the positive deviations are compared with the first reference deviation, and the negative deviations are compared with the second reference deviation. As a result of the comparison, among the measured data, first defective data whose deviation to the smoothed data has a positive value and is greater than the first reference deviation is corrected, and second defective data whose deviation has a negative value and also has an absolute value greater than an absolute value of the second reference deviation is corrected.

In an embodiment, if the same reference deviation is applied to the positive deviation and the negative deviation, the positive deviations are compared with the reference deviation as above, and the absolute values of the negative deviations are compared with the reference deviation. In other words, with respect to the positive or negative deviation, an absolute value of the deviation is compared with the reference deviation. As a result of the comparison, among the measured data, defective data whose deviation to the smoothed data has an absolute value not smaller than the reference deviation is corrected.

The defective data may be corrected in various ways, for example through a following method.

In an embodiment, the defective data is corrected regardless how much the defective data deviates in comparison to most measured data around the corresponding data.

If the first reference deviation and the second reference deviation are determined, the first defective data (xⱼ) may be corrected into a sum (x̅ⱼ+γ′₁Δ̅x̅₊̅) of the smoothed data of the corresponding data and γ′₁ times of the first average, and the second defective data (xⱼ) may be corrected into a sum (x̅ⱼ+γ′₂Δ̅x̅₋̅) of the smoothed data of the corresponding data and γ′₂ times of the second average. γ′₁ and γ′₂ may have relations with γ (namely, γ₁ and γ₂) which are factors determining the reference deviation, and for example, may have a value of 0 or above and γ or below. γ′₁ and γ′₂ may have the same value or different values.

If the same reference deviation is applied to the positive deviation and the negative deviation, the defective data (x₁) whose deviation to the smoothed data has a positive value may be corrected into a sum (x̅ⱼ+γ′₁Δ̅x̅) of the smoothed data of the corresponding data and γ′₁ times of the average of absolute values of the deviations, and the defective data (xⱼ) whose deviation to the smoothed data has a negative value may be corrected to a value (x̅ⱼ+γ′₂Δ̅x̅) obtained by subtracting γ′₂ times of the average of absolute values of the deviations from the smoothed data of the corresponding data.

In an embodiment, the defective data is corrected by reflecting how much the defective data deviates from a width where most surrounding measured data are present. For example, the defective data may be corrected on the basis of a greatest value among absolute values of the deviations of the defective data and the smoothed data, a greatest value among absolute values of the positive deviations, or a greatest value among absolute values of the negative deviations.

For example, if the first reference deviation and the second reference deviation are determined, the first defective data (xⱼ) may be corrected as in Equation 7 below on the basis of a first maximum deviation (Δxⱼ^{M}) which is a greatest value among the positive deviations, and the second defective data (xⱼ) may be corrected as in Equation 8 below on the basis of a second maximum deviation (Δxⱼ^{M}) which has a greatest absolute value among the negative deviations.

$$\begin{matrix}\overline{{x}_{j}} + ( \frac{Δ {x}_{j} - {γ}_{1} \overline{Δ {x}_{+}}}{Δ {x}_{j}^{M} - {γ}_{1} \overline{Δ {x}_{+}}} ) * {γ}_{1} Δ {x}_{+} & Equation 7 \\ \overline{{x}_{j}} + ( \frac{{γ}_{2} \overline{Δ {x}_{-}} - Δ {x}_{j}}{{γ}_{2} \overline{Δ {x}_{-}} - Δ {x}_{j}^{m}} ) * {γ}_{2} \overline{Δ {x}_{-}} & Equation 8\end{matrix}$$

By correcting the defective data according to Equations 7 and 8, the defective data may be corrected into a range satisfying Equation 9 below, in proportion to a magnitude of the deviation to the smoothed data.

x̅ⱼ+γ₂Δ̅x̅₋̅≦x̅ⱼ≦x̅ⱼ+γ₁Δ̅x̅₊̅ Equation 9

Equations 7 and 8 above are just an exemplary correcting method, and in the present disclosure, the method for correcting defective data on the basis of maximum deviations with respect to absolute values of the positive deviations and the negative deviations is not limited thereto. For example, even though the same reference deviation is applied to the positive deviation and the negative deviation, the defective data may be corrected similar to Equations 7 and 8 on the basis of a greatest value among the positive deviations and a greatest absolute value among the negative deviations. In this case, Δ̅x̅ of Equation 3 is applied instead of Δ̅x̅₊̅ of Equation 7, and −Δ̅x̅ is applied instead of Δ̅x̅−̅ of Equation 8.

The method for correcting measured data according to the present disclosure may be modified in various ways, and for example, any one method for determining a reference deviation and any one method for correcting defective data may be combined.

The effects of the method for correcting measured data described above may be understood by comparing FIGS. 15 to 18.

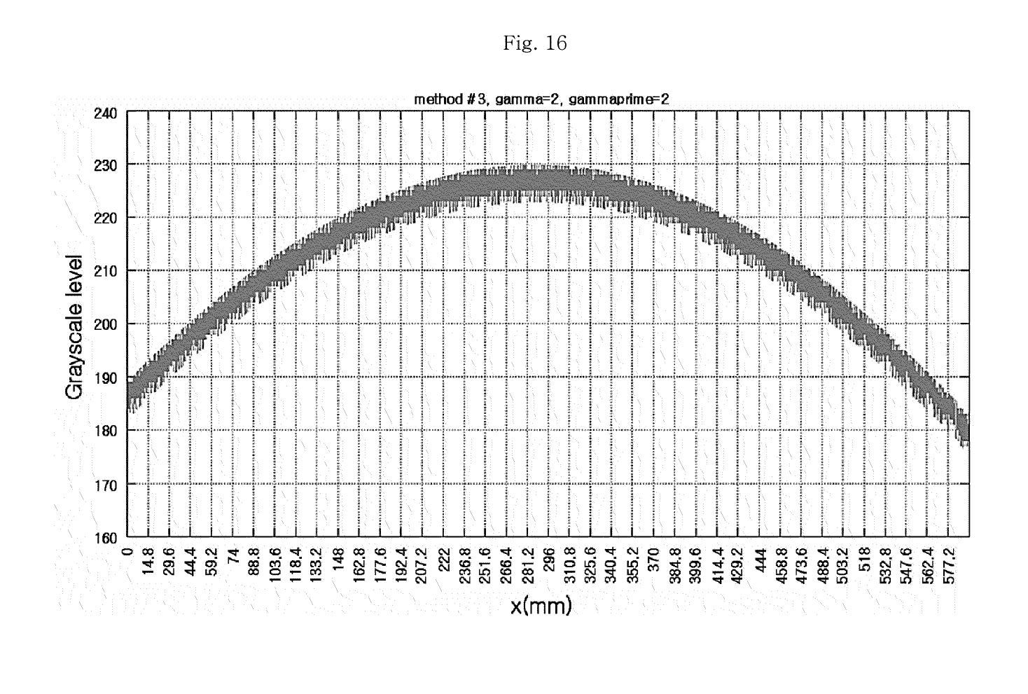

FIG. 15 shows an example of raw data obtained by measuring luminous intensity of a linear light source. Referring to FIG. 15, defective data seriously deviating from a trajectory of a curve formed by most measured data are observed here and there. Meanwhile, FIG. 16 shows a result obtained by applying the method for correcting measured data according to an embodiment of the present disclosure to the raw data of FIG. 15. The same reference deviation was applied to the positive deviation and the negative deviation, and defective data was corrected without distinguishing maximum deviations of the positive deviation and the negative deviation. Referring to FIG. 16, it may be found that the defective data is corrected in comparison to FIG. 15.

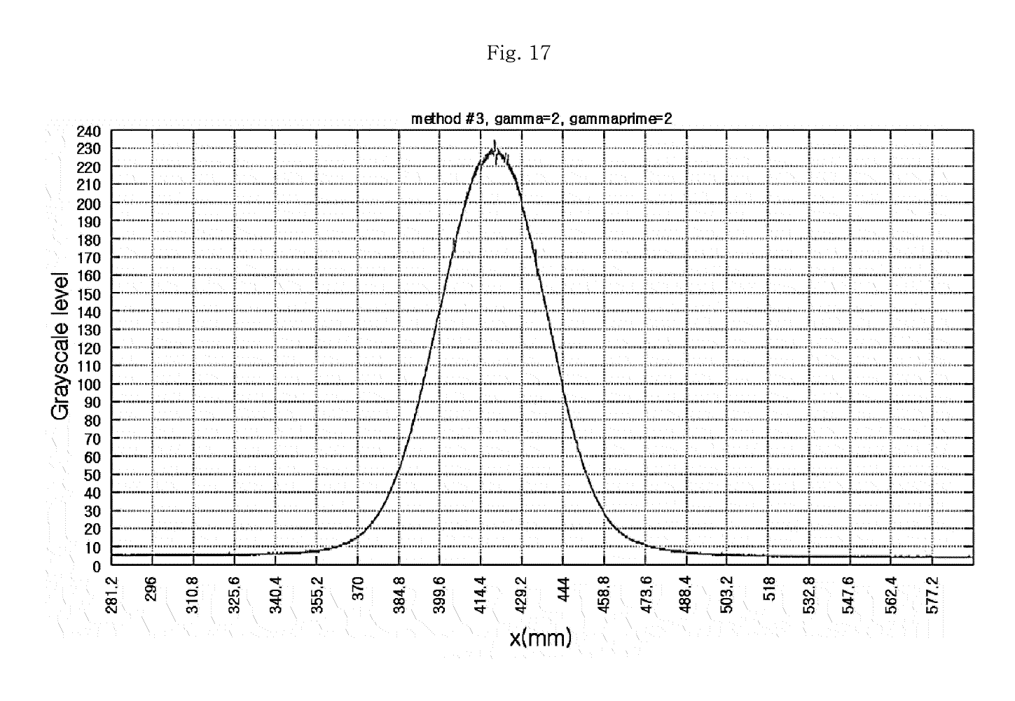

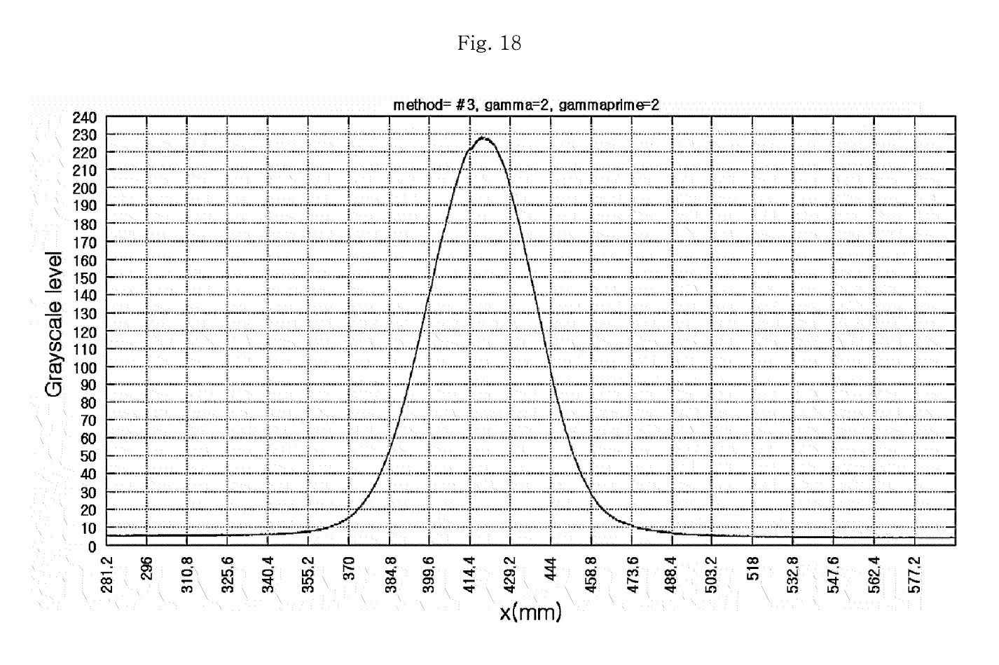

In addition, FIG. 17 shows an example of raw data obtained by measuring luminous intensity with respect to one viewpoint of an autostereoscopic image display device, and defective data are observed near a maximum value. Meanwhile, FIG. 18 shows a result obtained by applying the method for correcting measured data according to an embodiment of the present disclosure to the raw data of FIG. 17. Similar to FIG. 16, the same reference deviation was applied to the positive deviation and the negative deviation, and defective data was corrected without distinguishing maximum deviations of absolute values of the positive deviation and the negative deviation. Referring to FIG. 18, it may be found that the defective data is corrected in comparison to FIG. 17.

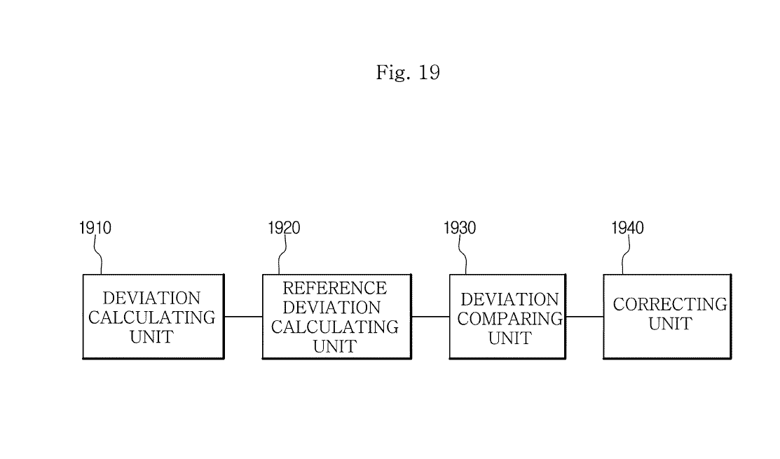

FIG. 19 is a block diagram showing a measured data correcting device according to an embodiment of the present disclosure. The measured data correcting device according to an embodiment of the present disclosure may be configured to perform the method for correcting measured data according to the above embodiment.

Referring to FIG. 19, the measured data correcting device includes a deviation calculating unit 1910 for calculating deviations of measured data and smoothed data obtained by smoothing the measured data, a reference deviation calculating unit 1920 for calculating a reference deviation for determining data to be corrected on the basis of the deviations, a deviation comparing unit 1930 for comparing the deviations with the reference deviation, and a correcting unit 1940 for correcting the measured data according to a comparison result of the deviations and the reference deviation.

In order to ensure data with better accuracy and reliability, a method for processing measured data according to an embodiment of the present disclosure may include determining an optimum reference data number (Nc) with respect to measured data according to the method of the above embodiment, correcting defective data according to the measured data correcting method of the above embodiment, and then smoothing the corrected data on the basis of the optimum reference data number (Nc).

In other case, after correcting defective data, a new optimum reference data number (Nc′) may be determined with respect to the corrected measured data according to the method for determining an optimum reference data number according to the above embodiment, and the corrected data may be smoothed on the basis of the determined optimum reference data number (Nc′).

While the present disclosure has been described with reference to the embodiments depicted in the drawings, it will be understood by those skilled in the art that it is just an example and various changes and modifications may be made thereto. However, such modifications should be regarded as falling within the scope of the present disclosure. Therefore, the true scope of the present disclosure should be defined by the appended claims.

1. A method for determining an optimum reference data number, comprising:
smoothing measured data on the basis of different data numbers;
obtaining a deviation of measured data before the smoothing or pre-smoothing measured data, and the smoothed measured data; and
determining an optimum reference data number on the basis of the deviation.

2. The method for determining an optimum reference data number according to claim 1,
wherein the smoothing of measured data on the basis of different data numbers includes:
smoothing the measured data on the basis of a first data number; and
smoothing the measured data on the basis of a data number smaller than the first data number,
wherein the first data number is a data number corresponding to a width of a measured data profile, a value not greater than a half of the data number corresponding to the width of the measured data profile, or a maximum value of measured data having the same value in the measured data profile.

3. The method for determining an optimum reference data number according to claim 1,
wherein the obtaining of a deviation of the pre-smoothing measured data and the smoothed measured data includes:
obtaining a deviation index calculated using a magnitude of the deviations of the pre-smoothing measured data and measured data smoothed on the basis of a specific data number.

4. The method for determining an optimum reference data number according to claim 3,
wherein the determining of an optimum reference data number on the basis of the deviation includes:
calculating a change rate of the deviation index according to a reference data number; and
determining the optimum reference data number on the basis of a reference data number when the change rate of the deviation index is a smallest non-negative value or a minimum.

5. The method for determining an optimum reference data number according to claim 3,
wherein the deviation index is a root mean square (RMS) value of the deviations or an average of absolute values of the deviations.

6. The method for determining an optimum reference data number according to claim 1,
wherein the smoothing is performed by means of moving average or Savitzky-Golay fitting.

7. A measured data smoothing device, comprising:
a reference data number determining unit configured to determining a reference data number for smoothing;
a smoothing unit configured to smooth measured data on the basis of the data number determined by the reference data number determining unit;
a deviation calculating unit configured to calculate a deviation of the pre-smoothing measured data and the smoothed measured data; and
an optimum reference data number determining unit configured to determine an optimum reference data number on the basis of the deviation calculated by the deviation calculating unit.

8. The measured data smoothing device according to claim 7,
wherein the reference data number determining unit determines a data number corresponding to a width of a measured data profile, a value not greater than a half of the data number corresponding to the width of the measured data profile, or a maximum value of data numbers having the same value, as a first reference data number, and determines a value smaller than the first reference data number as a second reference data number.

9. The measured data smoothing device according to claim 7,
wherein the deviation calculating unit obtains a deviation index calculated using a magnitude of the deviations of the pre-smoothing measured data and measured data smoothed on the basis of a specific data number.

10. The measured data smoothing device according to claim 9,
wherein the optimum reference data number determining unit includes a deviation change rate calculating unit configured to calculate a change rate of the deviation index according to a reference data number, and determines the optimum reference data number as a reference data number when the change rate of the deviation index is a smallest non-negative value or a minimum.

11. The measured data smoothing device according to claim 9,
wherein the deviation index is a root mean square (RMS) value of the deviations or an average of absolute values of the deviations.

12. The measured data smoothing device according to claim 7,
wherein the smoothing is performed by means of moving average or Savitzky-Golay fitting.

13. A method for correcting measured data, comprising:
obtaining deviations of measured data and smoothed data obtained by smoothing the measured data;
obtaining a reference deviation on the basis of the deviations; and
correcting the measured data on the basis of the reference deviation.

14. The method for correcting measured data according to claim 13,
wherein the obtaining of deviations includes:
obtaining the smoothed data by smoothing the measured data on the basis of the optimum reference data number determined by the method for determining an optimum reference data number,
wherein the method for determining an optimum reference data number comprising,
smoothing measured data on the basis of different data numbers;
obtaining a deviation of measured data before the smoothing or pre-smoothing measured data, and the smoothed measured data; and
determining an optimum reference data number on the basis of the deviation,
determining an optimum reference data number on the basis of the deviation.

15. The method for correcting measured data according to claim 13,
wherein the obtaining of a reference deviation on the basis of the deviations includes:
calculating a first average which is an average of deviations having a positive value among the deviations;
determining a first reference deviation on the basis of the first average;
calculating a second average which is an average of deviations having a negative value among the deviations; and
determining a second reference deviation on the basis of the second average,
wherein the correcting of the measured data on the basis of the reference deviation includes:
comparing the deviations having a positive value with the first reference deviation;
correcting a first defective data whose deviation to the smoothed data has a positive value and is greater than the first reference deviation, among the measured data;
comparing the deviations having a negative value with the second reference deviation; and
correcting a second defective data whose deviation to the smoothed data has a negative value and whose absolute value is greater than an absolute value of the second reference deviation, among the measured data.

16. The method for correcting measured data according to claim 13,
wherein the obtaining of a reference deviation on the basis of the deviations includes:
calculating an average of absolute values of the deviations; and
determining the reference deviation on the basis of the average of the absolute values of the deviations,
wherein the correcting of the measured data on the basis of the reference deviation includes:
comparing the absolute values of the deviations with the reference deviation;
correcting a first defective data whose deviation to the smoothed data has a positive value and is greater than the first reference deviation, among the measured data; and
correcting a second defective data whose deviation to the smoothed data has a negative value and whose absolute value is greater than the second reference deviation, among the measured data.

17. The method for correcting measured data according to claim 15,
wherein the correcting of a first defective data includes:
obtaining a first maximum deviation which has a positive value and whose absolute value is maximum, among the deviations; and
correcting the first defective data on the basis of the first maximum deviation,
wherein the correcting of a second defective data includes:
obtaining a second maximum deviation which has a negative value and whose absolute value is maximum, among the deviations; and
correcting the second defective data on the basis of the second maximum deviation.

18. A measured data correcting device, comprising:
a deviation calculating unit configured to calculate deviations of measured data and smoothed data obtained by smoothing the measured data;
a reference deviation calculating unit configured to calculate a reference deviation for determining data to be corrected, on the basis of the deviations;
a deviation comparing unit configured to compare the deviations with the reference deviation; and
a correcting unit configured to correct the measured data on the basis of the comparison result of the deviations and the reference deviation.

19. The measured data correcting device according to claim 18,
wherein the deviation calculating unit includes a measured data smoothing device comprising:
a reference data number determining unit configured to determining a reference data number for smoothing;
a smoothing unit configured to smooth measured data on the basis of the data number determined by the reference data number determining unit;
a deviation calculating unit configured to calculate a deviation of the pre-smoothing measured data and the smoothed measured data; and
an optimum reference data number determining unit configured to determine an optimum reference data number on the basis of the deviation calculated by the deviation calculating unit.

20. The measured data correcting device according to claim 18,
wherein the reference deviation calculating unit includes an average calculating unit for calculating a first average which is an average of deviations having a positive value among the deviations and a second average which is an average of deviations having a negative value among the deviations, determines a first reference deviation on the basis of the first average, and determines a second reference deviation on the basis of the second average,
wherein the deviation comparing unit compares the deviations having a positive value with the first reference deviation and compares the deviations having a negative value with the second reference deviation, and
wherein the correcting unit corrects a first defective data whose deviation to the smoothed data has a positive value and is greater than the first reference deviation and a second defective data whose deviation to the smoothed data has a negative value and whose absolute value is greater than an absolute value of the second reference deviation, among the measured data.

21. The measured data correcting device according to claim 18,
wherein the reference deviation calculating unit includes an average calculating unit for calculating an average of absolute values of the deviations, and determines the reference deviation on the basis of the average of the absolute values of the deviations,
wherein the deviation comparing unit compares the absolute values of the deviations with the reference deviation, and
wherein the correcting unit corrects a first defective data whose deviation to the smoothed data has a positive value and is greater than the first reference deviation and a second defective data whose deviation to the smoothed data has a negative value and whose absolute value is greater than the second reference deviation, among the measured data.

22. The measured data correcting device according to claim 20,
wherein the correcting unit includes a maximum deviation determining unit for determining a first maximum deviation which has a positive value and whose absolute value is maximum, among the deviations, and a second maximum deviation which has a negative value and whose absolute value is maximum, among the deviations, corrects the first defective data on the basis of the first maximum deviation, and corrects the second defective data on the basis of the second maximum deviation.

23. A method for processing measured data, comprising:
correcting measured data by using the method for correcting measured data, defined in claim 13;
determining an optimum reference data number by:
smoothing the measured data on the basis of different data numbers;
obtaining a deviation of the measured data before the smoothing or pre-smoothing measured data, and the smoothed measured data; and
determining an optimum reference data number on the basis of the deviation; and
smoothing the corrected measured data on the basis of the determined optimum reference data number.
